(19) United States
(12) Patent Application Publication
(10) Pub. No.: US 2020/0148181 A1
(43) Pub. Date: May 14, 2020

(54) Hydraulic Brakes

(71) Applicant: Parth Tirath Shah, Davie, FL (US)

(72) Inventor: Parth Tirath Shah, Davie, FL (US)

(21) Appl. No.: 16/186,535

(22) Filed: Nov. 10, 2018

(51) Int. Cl. B60T 8/48; B60T 11/10; B60T 13/14; B60T 13/66; F16D 57/00; F16D 57/02

(52) U.S. Cl. CPC B60T 8/4827; B60T 11/103; F16D 57/02; B60T 13/66; F16D 57/002; B60T 13/148

(57) ABSTRACT

This invention seeks to replace traditional brakes with a safer and more economical design. The traditional design uses friction to slow a vehicle, while the proposed design uses hydraulic fluid to slow down the motion of a vehicle. The rotor blade, whose design is shown in FIG. 1B, is mounted upon the bearing and is housed with the hydraulic fluid in the housing in FIG. 1A.

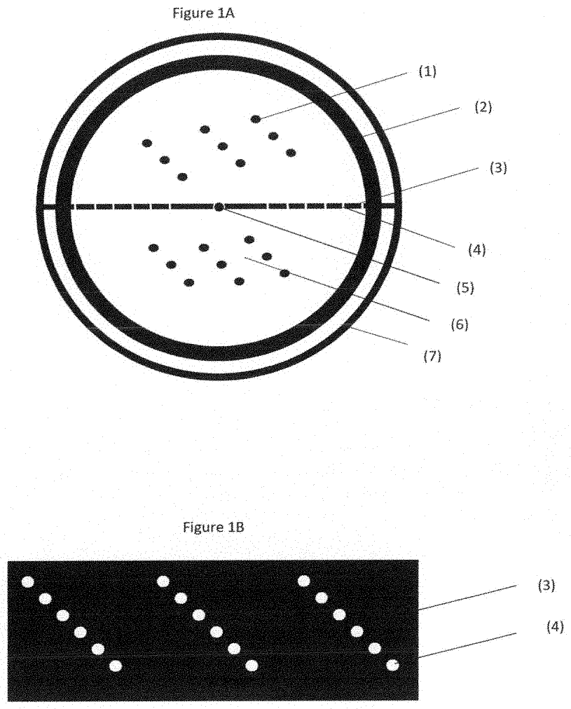

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAMMING LISTING COMPACT DISC APPENDIX

Not Applicable

### BACKGROUND OF THE INVENTION

The apparatus of moving vehicles known as the brakes are an often used when the vehicle must slow down. The current design for brakes requires the touching of two elements, and uses friction to slow down the vehicle. This design raises safety concerns in high performance automobiles and aircraft which often overheat during strenuous operation. Furthermore, the current design requires replacement of the brake pads when they wear out, a process that is costly. Previously, the traditional steel brake pads of a vehicle or any other apparatus which requires brakes could be upgraded with carbon brakes which provided longer durability and higher performance along with a lower weight. However, even with this innovation, the brakes were still at risk of overheating. Furthermore, carbon brakes, although longer lasting than their steel counterparts, still require replacement and in sectors such as aviation where planes make several flights over the course of a year and given the advanced nature of the carbon brakes, this becomes exceedingly expensive.

### SUMMARY OF THE INVENTION

By using hydraulics to dampen to rotational motion of the device, this design reduces the costs of operation by eliminating the need for frequent brake pad changes and its design minimizes the risk of fires that was previously prominent with conventional braking methods.

This process of applying the brakes works by:
1. Using a fluid to dampen the rotational movement

This can be accomplished by using the rotational movement to compress a hydraulic fluid.

In the same design of this proposal, the strength of the braking process can be controlled by
by using a gearbox to allow more turns of the rotor should a conventional fluid be used
by increasing the electrical fields should a magneto-rheological (MR) fluid be used
Any other method which requires more rotational motion to turn the rotor blades within the casing
By allowing the manipulation of the rotational motion needed to turn the internal rotor, the rate of slowing down the rotational motion is controlled.

### BRIEF DESCRIPTIONS OF THE SEVERAL VIEWS OF THE DRAWINGS

The graphic A included shows a cross section of the device, and includes a rotor consisting of two rotor blades, and a stator filled with hydraulic fluid (exact fluid depends on the use). The outer circle is the cylindrical housing and is filled with hydraulic fluid. The rotor is mounted on the bearing.

The graphic B depicts a sample of the rotor blades, with holes to allow the hydraulic fluid to move.

### DETAILED DESCRIPTION OF PREFERRED EMBODIMENTS

There are multiple embodiments of the proposed design, however, one of these designs are described.

The first embodiment consists of a cylindrical casing (7) of a sturdy material (composites may be preferred when weight is of importance) in which a bearing is mounted in the center. A driveshaft is mounted on that bearing (5) and penetrates the case on both sides allowing for attachments on both sides of the casing. The drive shaft is in the center of the base and top of the casing (which when seen from above or below appears as a circle) The drive shaft is a large cylinder of a sturdy material and can fit in the bearing. Upon the drive shaft, two rotor blades (3) of a sturdy material are mounted. These blades fit in their entirety within the casing. These blades have holes (4) in them (the exact number, shape and size of these holes depend on the specifications needed). The rest of the space in this cylinder is occupied by a fluid (6). This embodiment will use a method to increase resistance, in this case a magnetorheological system is used where electromagnets (2) embedded in the cylindrical case structure are activated, and magnetizing iron chips (1) in the fluid. This will cause the firming of the fluid, increasing the resistance of the brakes, and requiring more rotational torque to allow the wheels to continue spinning. The brake is made of a cylindrical housing, in which a rotor with two blades mounted upon a central bearing. The rotor blades are made of titanium and have milled holes in them. The brake housing is filled with a fluid. The holes in the rotor blades allow for the fluid to travel through the holes. The energy required to turn the rotor dampens the speed of the vehicle and will effectively slow the vehicle.

1. (canceled)

2. (canceled)

3. (canceled)

4. (canceled)

5. An apparatus that uses hydraulic fluid to dampen rotational motion to bring a vehicle to a stop
